(19) United States
(12) Patent Application Publication
(10) Pub. No.: US 2010/0171386 A1
(43) Pub. Date: Jul. 8, 2010

(54) ROTOR FOR MAGNET-EMBEDDED MOTOR AND MAGNET-EMBEDDED MOTOR

(75) Inventors: Tomonari Kogure, Toyota-shi (JP); Masaaki Hiraga, Gamagoori-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi, Aichi (JP)

(21) Appl. No.: 12/602,056

(22) PCT Filed: May 27, 2008
(86) PCT No.: PCT/JP2008/060114

§ 371 Date: Nov. 25, 2009

(30) Foreign Application Priority Data
May 28, 2007 (JP) 2007-140523

(51) Int. Cl. H02K 1/27

(52) U.S. Cl. 310/156.43

(57) ABSTRACT

The present invention provides a rotor a for magnet-embedded motor and a magnet-embedded motor whereby the manufacturing cost thereof can be significantly reduced while securing desired coercive force and magnetic flux density. A rotor for a magnet-embedded motor which comprises a plurality of permanent magnets 21 embedded therein, wherein each permanent magnet 21 is formed with a plurality of magnetic regions A to D having different coercive forces that are determined based on the intensity of the inverse magnetic field that acts on each permanent magnet 21, provided that a magnetic region having a relatively large coercive force is designated to be a region that is influenced by a relatively large inverse magnetic field.

### TECHNICAL FIELD

The present invention relates to a rotor for a magnet-embedded motor, in which permanent magnets are embedded, and a magnet-embedded motor comprising such rotor.

### BACKGROUND ART

Magnet-embedded motors (interior permanent magnet (IPM) motors) can realize higher torque and higher efficiency than surface permanent magnet motors (SPM motors). This is because a magnet-embedded motor comprises a rotor in which permanent magnets are embedded, thereby allowing generation of reluctance torque in addition to magnetic torque derived from the attractive force/repulsive force between a coil and permanent magnets. Meanwhile, an SPM motor comprises a rotor having permanent magnets attached to the circumference area thereof. Hence, magnet-embedded motors are used as, for example, driving motors for hybrid vehicles and electric vehicles in which high output performance must be achieved.

In an IPM motor such as that described above, a negative d-axis electric current flows upon current-phase control such that an inverse magnetic field that is generated by the electric current acts on each permanent magnet. When such inverse magnetic field is large, irreversible demagnetization occurs to a permanent magnet. Therefore, a permanent magnet to be used has high coercive force that can counteract such irreversible demagnetization. The above demagnetizing effects are described below based on FIG. 17. In FIG. 17, two permanent magnets M and M are positioned relative to a single pole. The two permanent magnets M and M are embedded in a manner such that they form an approximate V shape as seen from a plane view, the V shape extending from the rotational axis side of rotor A toward the stator B side. In such an IPM motor, portions in which large demagnetizing effects can be observed are the corner portions “a,” “b,” “c,” and “d” of permanent magnets M and M, which are located close to the outer peripheral area of the iron core of the rotor, and particularly, corners “b” and “c” on the d-axis side. In addition, magnetic flux short circuits are likely to be caused at the rotor core portion Al between the permanent magnets M and M. This also causes enlargement of an inverse magnetic field generated at the corner portions “b” and “c” of the permanent magnets M and M.

As an aside, rare earth magnets are generally used as permanent magnets in the above cases. Improved coercive force can be imparted to rare earth magnets with the addition of dysprosium (Dy) or terbium (Tb), which are high crystal magnetic anisotropic elements. Meanwhile, since such elements are rare and expensive, the addition of dysprosium or the like for the purpose of increasing permanent magnet coercive force directly results in a sharp increase in the manufacturing cost of permanent magnets. In the cases of permanent magnets used in conventional rotors for magnet-embedded motors, dysprosium or the like is used for the entirety of a permanent magnet in order to achieve the coercive force required for the aforementioned corner portions, resulting in a sharp increase in rotor manufacturing cost. Further, the residual magnetic flux density, which is an important indicator of permanent magnet performance as well as coercive force, tends to decrease as coercive force increases. Therefore, it is necessary to increase the number of magnets used in order to prevent reduction of magnetic flux density caused by increased magnet coercive force. This also results in a sharp increase in rotor manufacturing cost. Accordingly, in terms of mass production of hybrid vehicles and the like, it has been very important object to manufacture the above-described rotor comprising permanent magnets having desired coercive force that counteracts an inverse magnetic field at minimum cost.

Patent Documents 1 and 2 disclose techniques relating to the above-described magnet-embedded motor in which an inverse magnetic field is reduced. Both techniques are intended to reduce a large inverse magnetic field in a localized manner by forming air spaces on edge portions of a permanent magnet embedded in a rotor core.

Patent Document 1: JP Patent Publication (Kokai) No. 11-355985 A (1999)

Patent Document 2: JP Patent Publication (Kokai) No. 2003-143788 A

### DISCLOSURE OF THE INVENTION

In the cases of the rotors for a magnet embedded motor disclosed in Patent Document 1 and 2, an inverse magnetic field can be reduced by forming air spaces on edge portions of a permanent magnet. In the above cases, the coercive force of a permanent magnet is determined depending on the largest inverse magnetic field applied to the permanent magnet. Therefore, portions of the permanent magnet, which are less likely to be affected by the inverse magnetic field, have excessive coercive forces, resulting in a sharp increase in the material cost. This is one reason for a sharp increase in the cost of manufacturing magnet-embedded motors.

The present invention has been made in view of the above problems. It is an object of the present invention to provide a rotor for a magnet-embedded motor, which has coercive force that can counteract an inverse magnetic field acting on a permanent magnet and can be manufactured at low cost, and to provide a magnet-embedded motor comprising such rotor.

In order to attain the above object, the rotor for a magnet-embedded motor of the present invention is characterized in that it is a rotor for a magnet-embedded motor that comprises a plurality of permanent magnets embedded therein, and in which each permanent magnet is formed with a plurality of magnetic regions having different coercive forces that are determined based on the intensity of the inverse magnetic field that acts on each permanent magnet, provided that a magnetic region having a relatively large coercive force is designated to be a region that is influenced by a relatively large inverse magnetic field.

In the case of the rotor for a magnet-embedded motor of the present invention, each permanent magnet that is positioned in a slot inside the rotor comprises regions that are required to have different coercive forces. Therefore, the rotor comprises permanent magnets having regions with different coercive forces. In the case of such configuration, the amount of dysprosium (Dy), terbium (Tb), or the like to be used can be decreased to the minimum necessary level. As a result, the reduction of magnetic flux density can be inhibited to a minimum, resulting in a significant decrease in the rotor manufacturing cost.

Herein, in one embodiment of the rotor comprising permanent magnets arranged therein, a single permanent magnet is used for a single pole. For instance, in such case, a permanent magnet having a rectangular shape as seen from a plane view is provided in a manner such that the longitudinal side of the rectangle faces the stator side. In another embodiment, two permanent magnets are positioned relative to a single pole, provided that the two permanent magnets form an approximate V shape as seen from a plane view, such V shape extending from the rotor-rotational-axis side toward the stator side.

In either one of the above embodiments, demagnetization occurs to a great extent in corner portions of a permanent magnet as described above, and more specifically, in corner portions on the stator side of the permanent magnet. Therefore, it is preferable for such a corner portion to have a magnetic region containing dysprosium or the like in large quantities. For instance, in one embodiment in which a permanent magnet is formed into a rectangle as seen from a plane view, the plurality of magnetic regions are provided in a manner such that a corner portion region on the stator side of the rectangle is the region having the largest coercive force (first region), the region abutting the first region is the region having the second-largest coercive force (second region) after the first region, and another region is the region having the third-largest coercive force after the second region.

Herein, a summary of a method for manufacturing the aforementioned permanent magnets is provided below. One example of a method for allowing each region to have a different dysprosium content that can be used is a method for manufacturing permanent magnets involving, for example, a so-called dysprosium diffusion method. In addition, a method for manufacturing permanent magnets involving a so-called multicolor molding method can be used.

There are two other examples of the above dysprosium diffusion method. In one method, permanent magnets are immersed in a dysprosium fluoride (DyF₃) solution, followed by heating treatment so that dysprosium will permeate the permanent magnets. According to this method, it is possible to increase the dysprosium content in the outer peripheral portion of each permanent magnet while the dysprosium content inside the magnet can be relatively reduced, allowing each region of the permanent magnet to have a different coercive force.

In the other dysprosium diffusion method, a dysprosium film is formed on one side of a permanent magnet by sputtering treatment or deposition treatment, followed by heating treatment, such that it is possible to increase the dysprosium content on the film side and to reduce the dysprosium content gradually toward the non-film side. In such case, it is also possible to allow each region of a permanent magnet to have a different coercive force.

Also, there are two examples of a multicolor molding method. In one method, metal powders with different dysprosium contents are prepared. The powders are introduced into a mold such that each powder layer has a certain thickness, followed by pressure molding and then sintering.

In the other multicolor molding method, metal powders with different dysprosium contents are prepared and the powders are introduced into a mold in a similar manner, followed by hot extrusion. For instance, metal powders with different dysprosium contents are introduced into a mold such that regions having different coercive forces are formed. Thus, an extruded permanent magnet comprises a plurality of regions each having a different dysprosium content, depending on the necessary coercive force.

According to any one of the above manufacturing methods, it is possible to obtain a permanent magnet in which the dysprosium content or the terbium content in each region is adjusted depending on the necessary coercive force. Such permanent magnet has optimized (minimum necessary) coercive force. Therefore, reduction of the magnetic flux density thereof is inhibited to a minimum. Accordingly, the necessary quantity of magnet for obtaining a certain magnetic torque can be reduced to a minimum. In view of the above, compared with the cases of conventional IPM motors, the cost of manufacturing permanent magnets to be embedded in a rotor can be significantly reduced, leading to the reduction of the rotor manufacturing cost.

Further, in addition to the embodiment in which each magnetic region contains dysprosium (Dy) or terbium (Tb) in a different amount, a magnet may be composed of different materials in different regions in one embodiment. For instance, in descending order of coercive force, there are neodymium magnets, samarium cobalt magnets, and ferrite magnets. A single magnet can be formed by designating magnetic regions depending on required coercive forces and selecting a neodymium magnet, a samarium cobalt magnet, or a ferrite magnet for each region.

Further, in another embodiment of the rotor for a magnet-embedded motor of the present invention, each permanent magnet is formed into a rectangle as seen from a plane view. The plurality of magnetic regions are formed by dividing the rectangle into a plurality of regions in the longitudinal direction. The center region of the permanent magnet is the region having the smallest coercive force. The coercive force gradually increases in the divided regions toward the edge portion of the magnet.

In such embodiment, eddy loss can be reduced by dividing the rectangle into a plurality of coercive force regions of the permanent magnet in the longitudinal direction (providing a plurality of regions having slightly different coercive forces in the longitudinal direction).

Furthermore, in a preferred embodiment of the rotor for a magnet-embedded motor of the present invention, at least one of two corner portions of each permanent magnet that are located on the rotor-rotational-axis side is truncated as seen from a plane view such that the plane view of the permanent magnet corresponds to the plane view of the relevant permanent magnet insertion slot of the rotor core.

Even in a case in which a permanent magnet contains a plurality of different coercive force regions, it is practically impossible to visually confirm coercive force differences from the outside. Therefore, in the embodiment of the present invention, in order to adequately insert a permanent magnet having regions with different coercive forces into a magnet insertion slot of a rotor core, a portion is truncated from the permanent magnet in a manner such that the plane view of the permanent magnet corresponds to the plane view of a relevant permanent magnet insertion slot. In addition, in such embodiment, such a portion to be truncated is a portion that is less likely to contribute to the torque of a permanent magnet; that is to say, at least one of the two corner portions of a permanent magnet having a rectangular shape as seen from a plane view that are located on the rotor-rotational-axis side. In such configuration, a permanent magnet having a plurality of coercive force regions can be adequately positioned in a permanent magnet insertion slot while preventing the reduction of torque performance caused by formation of truncated portions.

A motor comprising the above rotor for a magnet-embedded motor of the present invention contains embeddable permanent magnets that have desired coercive force and magnetic flux density. In addition, the manufacturing cost of such motor is very reasonable. Therefore, such motor is preferable for hybrid vehicles and electric vehicles, which have been recently actively mass-produced and are expected to be equipped with high-performance driving motors.

As is understood from the above descriptions, according to the rotor for a magnet-embedded motor of the present invention, an embeddable permanent magnet is adjusted to have a dysprosium content or terbium content that depends on the necessary coercive force of each region. Therefore, the manufacturing cost thereof can be significantly reduced while securing desired coercive force and magnetic flux density. In addition, since eddy loss can be effectively reduced, a motor having excellent rotation performance and output performance can be obtained.

### BRIEF DESCRIPTION OF THE DRAWINGS

FIG. 1 is a plane view of a rotor obtained in one embodiment of the present invention comprising permanent magnets arranged in V shapes.

FIG. 2 is a plane view of an example of a permanent magnet embedded in the rotor shown in FIG. 1.

FIG. 3 is a graph showing the distribution of coercive forces of regions of the permanent magnet shown in FIG. 2 that is obtained in one embodiment of the present invention.

FIG. 4 is a graph showing the distribution of coercive forces in regions of a permanent magnet that is obtained in another embodiment of the present invention.

FIG. 5 is a plane view of a permanent magnet obtained in another embodiment of the present invention.

FIG. 6 is a graph showing the distribution of coercive forces in regions of the permanent magnet shown in FIG. 5.

FIG. 7 is a plane view of a rotor comprising permanent magnets arranged in V shapes obtained in another embodiment of the present invention.

FIG. 8 shows schematic plane views of analysis models for CAE analysis of inverse magnetic fields that act on permanent magnets.

FIGS. 9a, 9b, and 9c show results for the analysis model A shown in FIG. 8 (a concentrated winding IPM motor comprising permanent magnets arranged in V shapes). FIG. 9a is an enlarged view of permanent magnets. FIG. 9b shows analysis results for the permanent magnet Ma1. FIG. 9c shows analysis results for the permanent magnet Ma2.

FIGS. 10a and 10b show results for the analysis model B in FIG. 8 (a concentrated winding IPM motor comprising permanent magnets arranged in “-” shapes). FIG. 10a is an enlarged view of permanent magnets. FIG. 10b shows analysis results for the permanent magnet Mb.

FIGS. 11a, 11b, 11c, and 11d show results for the analysis model C in FIG. 8 (a concentrated winding IPM motor comprising permanent magnets arranged in triangular shapes). FIG. 11a is an enlarged view of permanent magnets. FIG. 11b shows analysis results for the permanent magnet Mc1. FIG. 11c shows analysis results for the permanent magnet Mcg. FIG. 11d shows analysis results for the permanent magnet Mc3.

FIGS. 12a and 12b show results for the analysis model D in FIG. 8 (a concentrated winding SPM motor). FIG. 12a is an enlarged view of permanent magnets. FIG. 12b shows analysis results for the permanent magnet Md.

FIGS. 13a, 13b, and 13c show results for the analysis model E in FIG. 8 (a distributed winding IPM motor comprising permanent magnets arranged in V shapes). FIG. 13a is an enlarged view of permanent magnets. FIG. 13b shows analysis results for the permanent magnet Me1. FIG. 13c shows analysis results for the permanent magnet Me2.

FIGS. 14a and 14b show results for the analysis model F in FIG. 8 (a distributed winding IPM motor comprising permanent magnets arranged in “-” shapes). FIG. 14a is an enlarged view of permanent magnets. FIG. 14b shows analysis results for the permanent magnet Mf.

FIGS. 15a, 15b, 15c, and 15d show results for the analysis model G in FIG. 8 (a distributed winding IPM motor comprising permanent magnets arranged in triangular shapes). FIG. 15a is an enlarged view of permanent magnets. FIG. 15b shows analysis results for the permanent magnet Mg1. FIG. 15c shows analysis results for the permanent magnet Mg2. FIG. 15d shows analysis results for the permanent magnet Mg3.

FIGS. 16a and 16b show results for the analysis model H in FIG. 8 (a distributed winding SPM motor). FIG. 16a is an enlarged view of permanent magnets. FIG. 16b shows analysis results for the permanent magnet Mh.

FIG. 17 explains that demagnetization differently influences each region of a permanent magnet in a conventional magnet-embedded motor.

In the figures, numerical references 1, 2 and 2A, 21 and 21A, 21B and 21C, 21B′ and 21C′, 3 and 3′, and 4a and 4b correspond to a rotor, permanent magnets arranged in a V shape, rectangular permanent magnets, permanent magnets having truncated portions, truncated portions, permanent magnet insertion slots, and a fixed resin portion, respectively. Alphabetical references A, B, C, and A1, B1, and C1 correspond to a first region, a second region, a third region, and magnets, respectively.

### BEST MODE FOR CARRYING OUT THE INVENTION

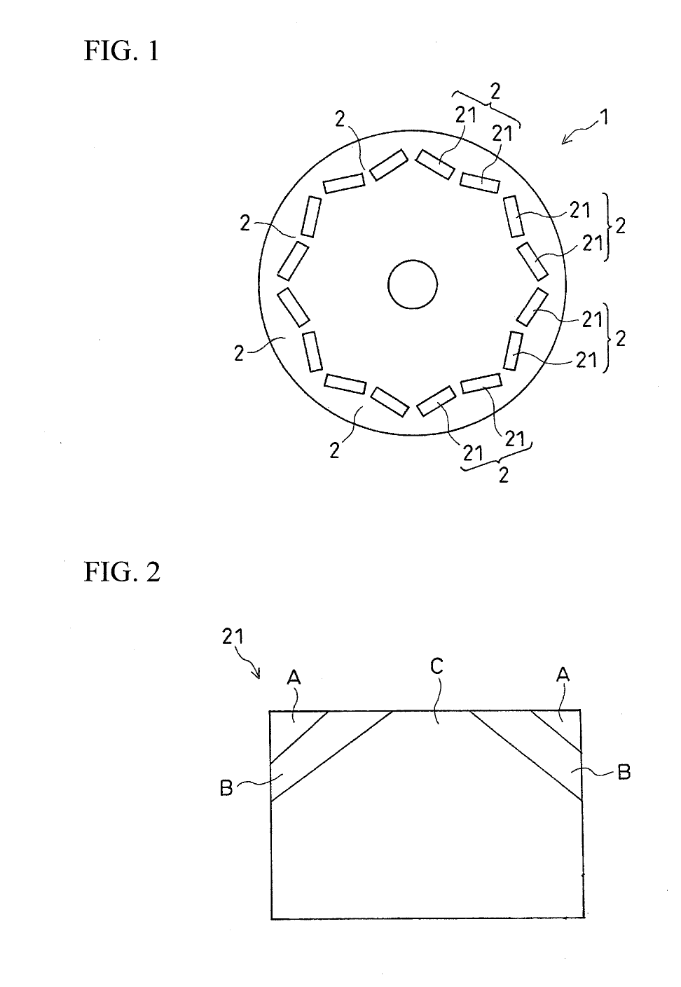

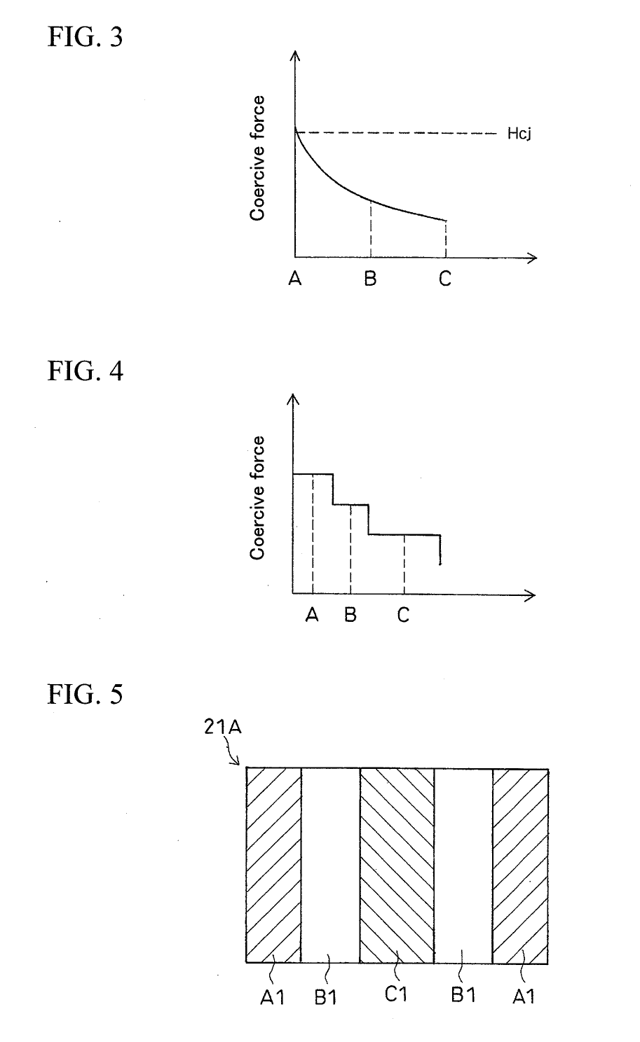

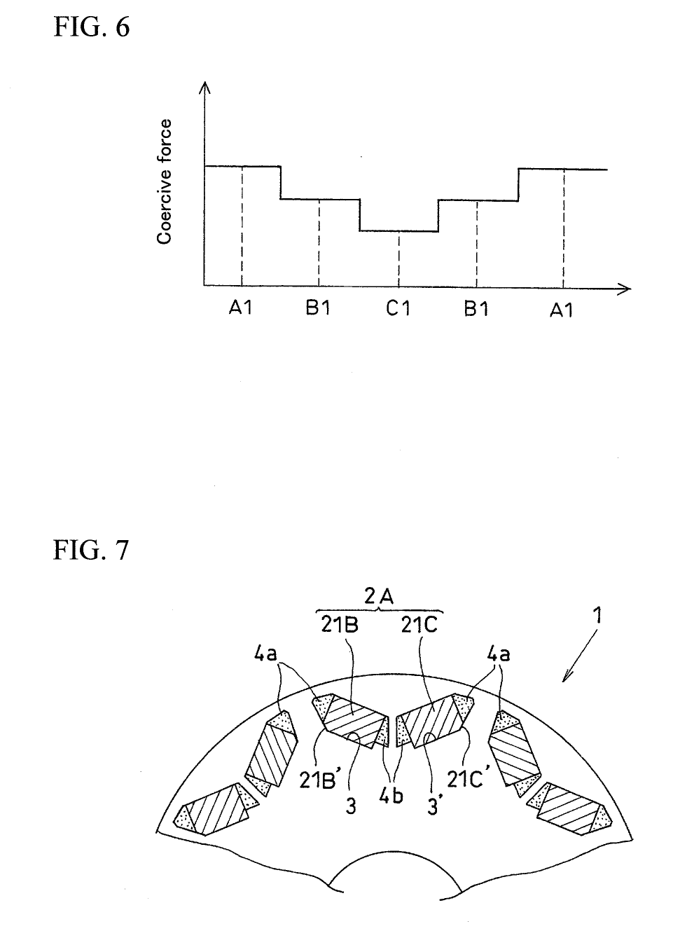

Embodiments of the present invention are hereafter described in greater detail with reference to the drawings. FIG. 1 is a plane view of the rotor of the present invention comprising permanent magnets arranged in V shapes. FIG. 2 is a plane view of an example of a permanent magnet embedded in the rotor shown in FIG. 1. Each of FIGS. 3 and 4 is a graph showing the distribution of coercive forces of regions of the permanent magnet shown in FIG. 2 that is obtained in one embodiment of the present invention. FIG. 5 is a plane view of a permanent magnet obtained in another embodiment of the present invention. FIG. 6 is a graph showing the distribution of coercive forces in regions of the permanent magnet shown in FIG. 5.

FIG. 1 shows one embodiment of the rotor for a magnet-embedded motor of the present invention. In the rotor 1, permanent magnets are inserted into and fixed within slots formed on a rotor core comprising a laminated steel plate or a dust core. More specifically, in such rotor, a V-shaped permanent magnet set 2 for a single pole is formed with permanent magnets 21 and 21, which have a rectangular shape as seen from a plane view and are inserted into slots that are arranged to form an approximate V shape (an approximate V shape formed with two rectangles with a gap therebetween) as seen from a plane view. Such sets are formed for a certain number of poles in the circumferential direction.

The above rotor is positioned in hollow portions (not shown) in the stator core; that is to say, hollow portions formed with a plurality of teeth that project inwardly in the radial direction from a yoke having an approximately circular shape as seen from a plane view. Accordingly, a magnet-embedded motor (IPM motor) is formed.

FIG. 2 shows an example of a permanent magnet embedded in the rotor shown in FIG. 1. A permanent magnet 21 is formed with a plurality of regions having different coercive forces. Each first region A, which is a stator-side corner portion, is adjusted to have the largest coercive force. Next, each second region B abutting the first region A is adjusted to have the second-largest coercive force. Subsequently, a center region C is adjusted to have the third-largest coercive force. In addition, the above coercive force regions are merely examples. A first region A may be a rectangular (non-triangular) region or a curved region. The other regions may be adequately formed into various shapes. However, at least a region formed on a corner portion located on the stator side is adjusted to have the largest coercive force while a region located on the side opposite to the stator side is adjusted to have a relatively small coercive force. Further, the area and the width of each region can be adequately adjusted based on material cost, target performance, or the like.

In addition, as shown in FIG. 3, the distribution of coercive forces of the first region A to the third region C may be a continuous coercive force distribution. Further, as shown in FIG. 4, it may be a coercive force distribution obtained by determining a certain coercive force for each region such that stepwise changes in coercive force can be observed in interfaces between regions.

Herein, an example of a method for manufacturing a permanent magnet 21 is summarized below. The manufacturing method herein described is based on a dysprosium diffusion method or the like. Specifically, a film of dysprosium or the like is formed on the upper face or both side faces of a permanent magnet by sputtering treatment or deposition treatment, followed by heat treatment. Thus, dysprosium is allowed to permeate the magnet through its surface. Accordingly, a permanent magnet 21 with a coercive force distribution as shown in FIG. 3 can be obtained.

FIG. 5 shows a permanent magnet obtained in another embodiment. The permanent magnet 21A is formed in a manner such that a rectangle is divided into a plurality of regions having different coercive forces in the longitudinal direction. A magnet C1 having the smallest coercive force is located in the center region. The coercive force increases toward a magnet B1 and then a magnet A1, the magnet B1 and the magnet A1 being located at edge portions.

As shown in FIG. 6, the coercive force distribution of a magnet A1 to a magnet C1 is a coercive force distribution in which stepwise changes in coercive force can be observed in interfaces between regions.

Herein, an example of a method for manufacturing a permanent magnet 21A is summarized below. The manufacturing method involves bonding of magnets having different coercive forces. Specifically, a magnet A1 with a large dysprosium content, a magnet B1 with a dysprosium content smaller than that of the magnet A1, and a magnet C1 with a dysprosium content smaller than that of the magnet B1 are prepared and bonded so as not to be separated from each other. Accordingly, a permanent magnet 21A having a coercive force distribution as shown in FIG. 6 can be obtained.

In the case of the permanent magnet 21A, the amount of dysprosium added can be optimized. In addition, since the permanent magnet is divided into different electrical regions, it can be expected to reduce eddy loss upon motor driving.

FIG. 7 shows the rotor for a magnet-embedded motor of the present invention obtained in another embodiment of the present invention. The figure shows an enlarged view of a V-shaped permanent magnet set 2A.

Two permanent magnets form a single pole. Truncated portions are formed at corner portions (located at the rotational axis of a rotor) of a permanent magnet 21B and a permanent magnet 21C, which are a front magnet and a rear magnet located along the rotational direction (arrow direction) of a rotor 1.

More specifically, a truncated portion 21B′ is formed on a rotational front corner portion of the permanent magnet 21B. A truncated portion 21C′ is formed on a rotational rear corner portion of the permanent magnet 21C. Regions in which truncated portions 21B′ and 21C′ are formed are located far from the rotor surface, and thus they are unlikely to contribute to torque performance. In addition, truncated portions may be formed on two corner portions located on the rotor-rotational-axis side for both permanent magnets 21B and 21C (not shown).

Herein, permanent magnet insertion slots 3 and 3′ are formed inside the rotor core in a manner such that plane views of permanent magnet insertion slots 3 and 3′ correspond to plane views of permanent magnets 21B and 21C, respectively. This allows permanent magnets 21B and 21C to be readily inserted into the corresponding permanent magnet insertion slots 3 and 3′ such that the coercive force regions of each permanent magnet are adequately positioned (in order to position regions having large coercive forces on the stator side of each permanent magnet).

In addition, in the figure, a resin-filling slot is formed on both sides of each of permanent magnet insertion slots 3 and 3′. For instance, a permanent magnet 21B is inserted into a permanent magnet insertion slot 3 and then resin-filling slots on both sides are filled with a resin, followed by curing. Thus, non-magnetic fixed resin portions 4a and 4b are formed. In a plane view, the fixed resin portions 4a and 4b are formed into the shapes shown in the figure such that flux leakage from, for example, corner portions of a permanent magnet 21B can be effectively prevented.

[CAE Analysis of an Inverse Magnetic Field that Acts on a Permanent Magnet and Analysis Results]

The present inventors prepared analysis models for comparison between concentrated winding and distributed winding SPM motors and concentrated winding and distributed winding IPM motors in which permanent magnets were arranged in V shapes, “-” shapes (in which a single magnetic pole is formed by a single permanent magnet facing the teeth side), or triangular shapes obtained by combining the above shapes (in which 3 permanent magnets are formed into an inverted triangle oriented toward the teeth side). The distribution of inverse magnetic fields that act on permanent magnets was obtained for each motor. Then, the maximum, minimum, and mean values of inverse magnetic filed were obtained.

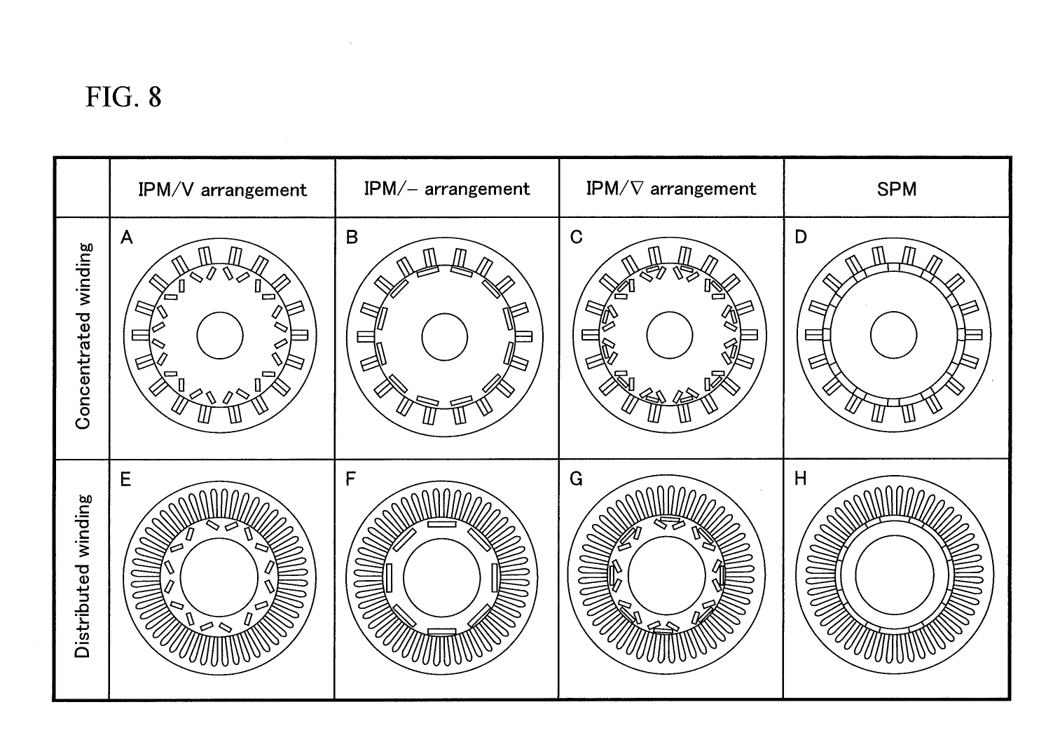

For analysis, JMAG-Studio Ver. 9.0 (JRI Solutions, Limited) was used as an analysis tool. Analysis was carried out with the use of, as analysis models, 8 cases of two-dimensional models of three-phase alternating current synchronous motors prepared as shown in FIG. 8. Upon analysis, each rotor was allowed to rotate in a counterclockwise direction (electric angle: 360 degree), during which the inverse magnetic field acting on a permanent magnet was calculated. In addition, energization was carried out under the following conditions: coil: 15 turns; electric current: 170 Arms; advance angle: an angle for the largest torque (for each model).

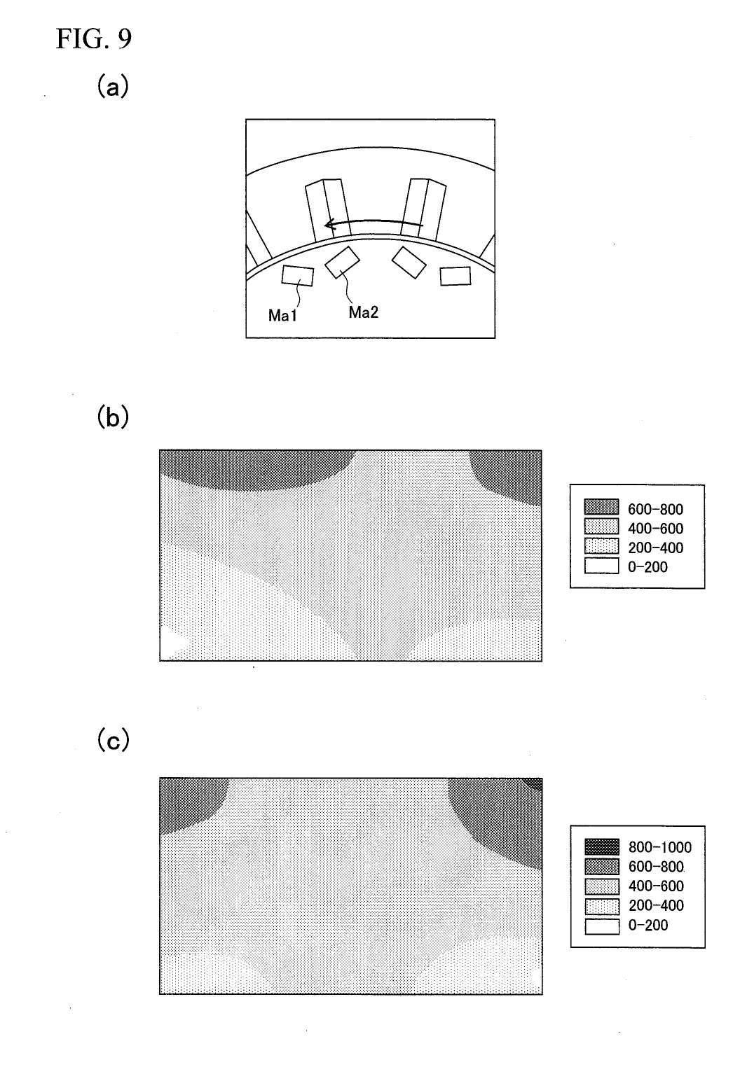

The analysis results for the individual cases are shown in FIGS. 9 to 16.

FIGS. 9a, 9b, and 9c show results for the analysis model A shown in FIG. 8 (a concentrated winding IPM motor comprising permanent magnets arranged in V shapes). FIG. 9a is an enlarged view of a permanent magnet (an arrow indicates the rotor rotational direction). FIG. 9b shows analysis results for the permanent magnet Ma1 (rotational front magnet). FIG. 9c shows analysis results for the permanent magnet Ma2 (rotational rear magnet). In addition, regions each having a relatively large inverse magnetic field shown in FIGS. 9b and 9c are regions on the stator side.

In FIG. 9b showing analysis results for the permanent magnet Ma1, the maximum value of inverse magnetic field was 751 (kA/m), the minimum value thereof was 85 (kA/m), and the mean value thereof was 474 (kA/m).

In FIG. 9c showing analysis results for the permanent magnet Ma2, the maximum value of inverse magnetic field was 877 (kA/m), the minimum value thereof was 108 (kA/m), and the mean value thereof was 498 (kA/m).

As shown in FIGS. 9b and 9c, in the cases of the permanent magnets Ma1 and Ma2, the largest inverse magnetic field was generated at both corner portions on the stator side while the smallest inverse magnetic field was generated at both corner portions on the rotor-rotational-axis side.

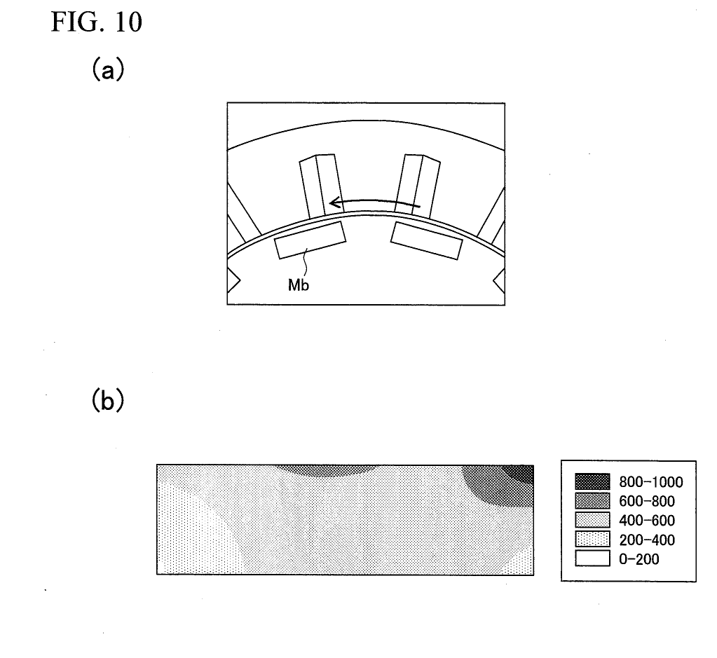

FIGS. 10a and 10b show results for the analysis model B in FIG. 8 (a concentrated winding IPM motor comprising permanent magnets arranged in “-” shapes). FIG. 10a is an enlarged view of permanent magnets. FIG. 10b shows analysis results for the permanent magnet Mb.

In FIG. 10b showing analysis results for the permanent magnet Mb, the maximum value of the inverse magnetic field was 1042 (kA/m), the minimum value thereof was 183 (kA/m), and the mean value thereof was 501 (kA/m).

The results in FIG. 10b show that in the case of the permanent magnet Mb, the largest inverse magnetic field was generated at the rotor-rotational rear corner portion on the stator side while the inverse magnetic field intensity decreased toward the corner portion on the rotor-rotational-axis side, which was located diagonally from the above corner portion.

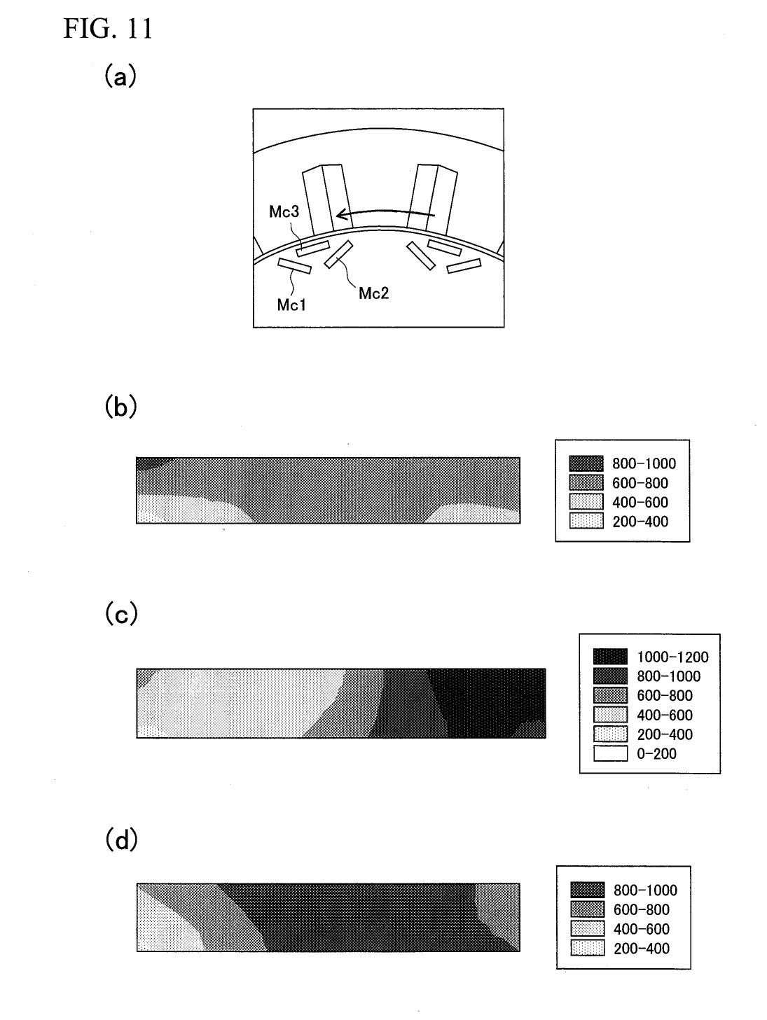

FIGS. 11a, 11b, 11c, and 11d show results for the analysis model C in FIG. 8 (a concentrated winding IPM motor comprising permanent magnets arranged in triangular shapes). FIG. 11a is an enlarged view of permanent magnets. FIG. 11b shows analysis results for the permanent magnet Mc1. FIG. 11c shows analysis results for the permanent magnet Mc2. FIG. 11d shows analysis results for the permanent magnet Mc3.

In FIG. 11b showing analysis results for the permanent magnet Mc1, the maximum value of inverse magnetic field was 899 (kA/m), the minimum value thereof was 171 (kA/m), and the mean value thereof was 613 (kA/m).

In FIG. 11c showing analysis results for the permanent magnet Mc2, the maximum value of inverse magnetic field was 1403 (kA/m), the minimum value thereof was 92 (kA/m), and the mean value thereof was 744 (kA/m).

In FIG. 11d showing analysis results for the permanent magnet Mc3, the maximum value of inverse magnetic field was 926 (kA/m), the minimum value there of was 341 (kA/m), and the mean value thereof was 792 (kA/m).

As shown in FIG. 11b, in the case of the permanent magnet Mc1, a substantially uniform inverse magnetic field was generated at each corner portion except for the rotor-rotational front corner portion on the stator side. In addition, the results in FIG. 11c show that in the cases of the permanent magnet Mc2, the largest inverse magnetic field was generated at the rotor-rotational rear corner portion on the stator side while the inverse magnetic field intensity decreased toward a corner portion on the rotor-rotational-axis side, which was located diagonally from the above corner portion. Further, as shown in FIG. 11d, in the case of the permanent magnet Mc3, a slightly large inverse magnetic field was generated in the center portion.

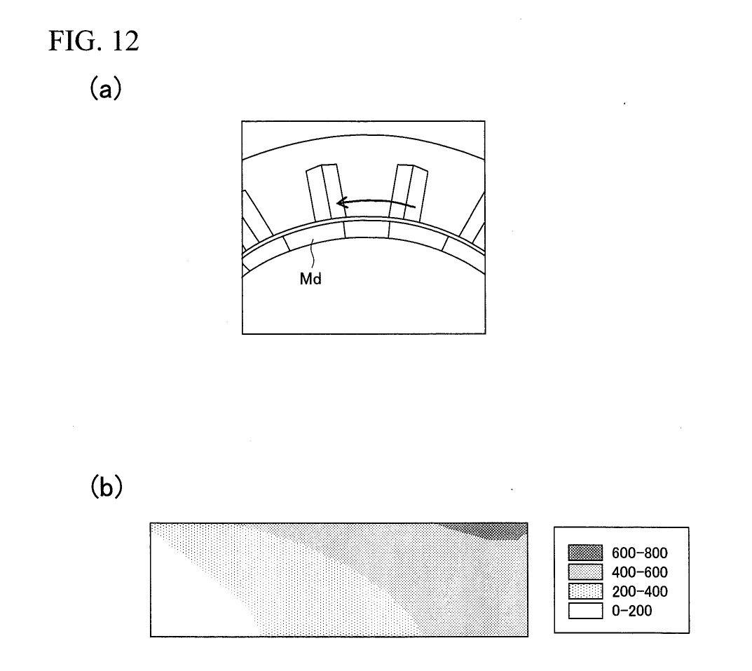

FIGS. 12a and 12b show results for the analysis model D in FIG. 8 (a concentrated winding SPM motor used as a model for comparison with IPM motors). FIG. 12a is an enlarged view of permanent magnets. FIG. 12b shows analysis results for the permanent magnet Md.

In FIG. 12b showing analysis results for the permanent magnet Md, the maximum value of inverse magnetic field was 693 (kA/m), the minimum value thereof was −4 (kA/m), and the mean value thereof was 364 (kA/m).

The results in FIG. 12b show that in the cases of the permanent magnet Md, the largest inverse magnetic field was generated at the rotor-rotational rear corner portion on the stator side while the inverse magnetic field intensity decreased toward a corner portion on the rotor-rotational-axis side, which was located diagonally from the above corner portion.

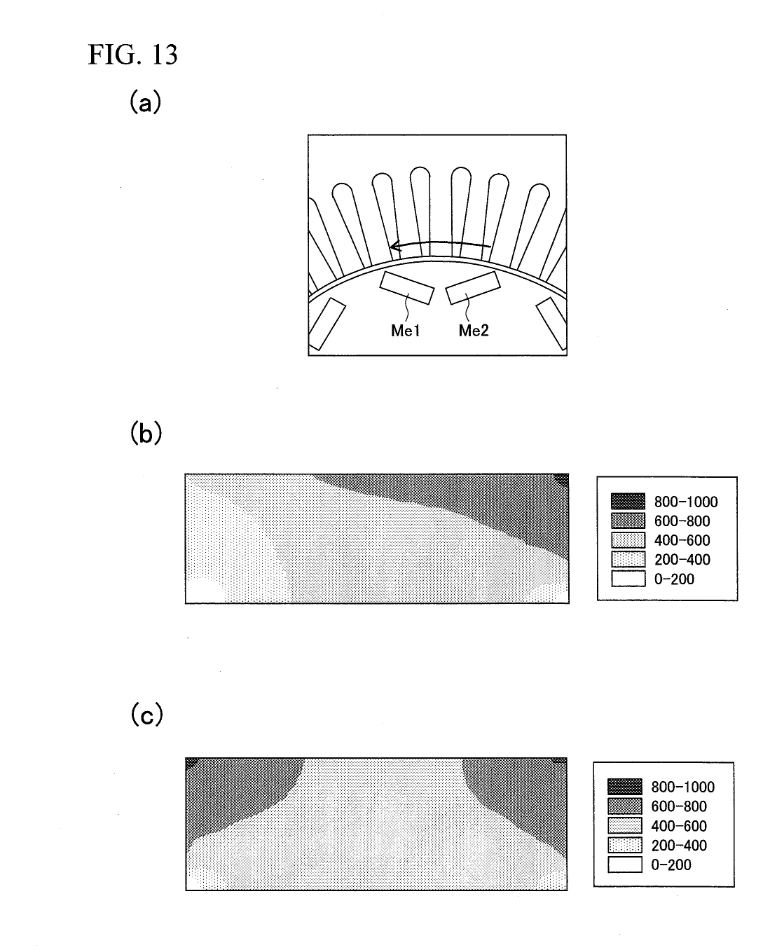

FIGS. 13a, 13b, and 13c show results for the analysis model E in FIG. 8 (a distributed winding IPM motor comprising permanent magnets arranged in V shapes). FIG. 13a is an enlarged view of permanent magnets. FIG. 13b shows analysis results for the permanent magnet Me1. FIG. 13c shows analysis results for the permanent magnet Me2.

In FIG. 13b showing analysis results for the permanent magnet Me1, the maximum value of inverse magnetic field was 899 (kA/m), the minimum value thereof was 10 (kA/m), and the mean value thereof was 501 (kA/m).

In FIG. 13c showing analysis results for the permanent magnet Me2, the maximum value of inverse magnetic field was 904 (kA/m), the minimum value thereof was 42 (kA/m), and the mean value thereof was 583 (kA/m).

The results in FIG. 13b show that in the cases of the permanent magnet Me1, the largest inverse magnetic field was generated at the rotor-rotational rear corner portion on the stator side while the inverse magnetic field intensity decreased toward a corner portion on the rotor-rotational-axis side, which was located diagonally from the above corner portion. In addition, as shown in FIG. 13c, in the case of the permanent magnet Me2, the largest inverse magnetic field was generated at both corner portions on the stator side while the smallest inverse magnetic field was generated at both corner portions on the rotor side.

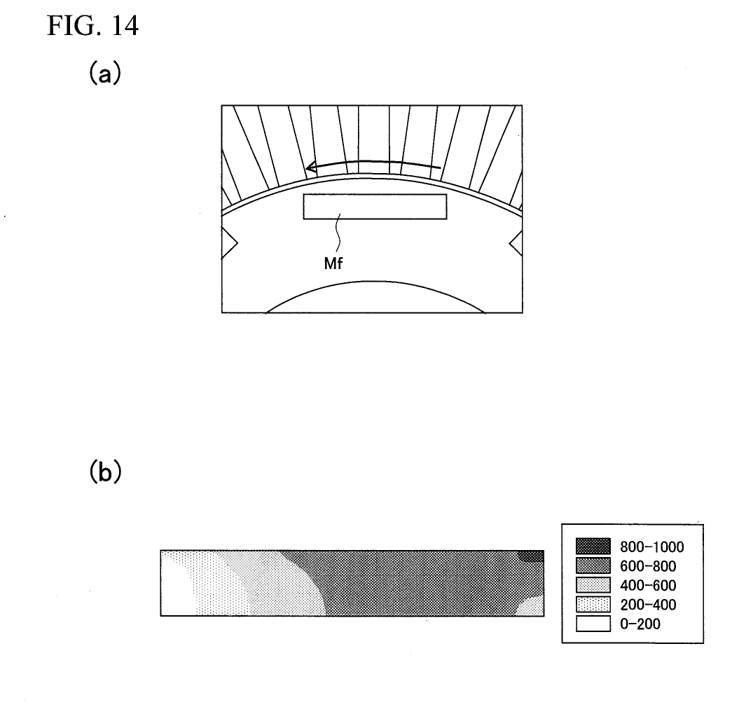

FIGS. 14a and 14b show results for the analysis model F in FIG. 8 (a distributed winding IPM motor comprising permanent magnets arranged in “-” shapes). FIG. 14a is an enlarged view of permanent magnets. FIG. 14b shows analysis results for the permanent magnet Mf.

In FIG. 14b showing analysis results for the permanent magnet Mf, the maximum value of inverse magnetic field was 974 (kA/m), the minimum value thereof was 78 (kA/m), and the mean value thereof was 555 (kA/m).

The results in FIG. 14b show that in the cases of the permanent magnet Mf, the largest inverse magnetic field was generated at the rotor-rotational rear corner portion on the stator side while the inverse magnetic field intensity decreased toward a corner portion on the rotor-rotational-axis side, which was located diagonally from the above corner portion.

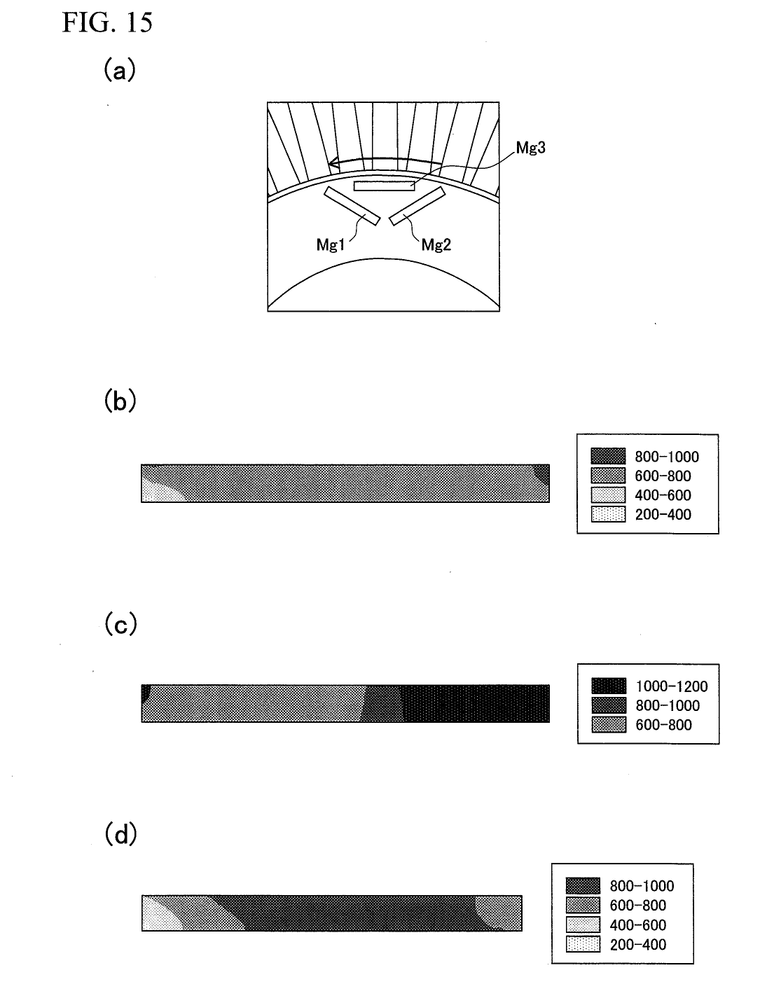

FIGS. 15a, 15b, 15c, and 15d show results for the analysis model G in FIG. 8 (a distributed winding IPM motor comprising permanent magnets arranged in triangular shapes). FIG. 15a is an enlarged view of permanent magnets. FIG. 15b shows analysis results for the permanent magnet Mg1. FIG. 15c shows analysis results for the permanent magnet Mg2. FIG. 11d shows analysis results for the permanent magnet Mg3.

In FIG. 15b showing analysis results for the permanent magnet Mg1, the maximum value of inverse magnetic field was 865 (kA/m), the minimum value thereof was 196 (kA/m), and the mean value thereof was 708 (kA/m).

In FIG. 15c showing analysis results for the permanent magnet Mg2, the maximum value of inverse magnetic field was 1277 (kA/m), the minimum value thereof was 335 (kA/m), and the mean value thereof was 870 (kA/m).

In FIG. 15d showing analysis results for the permanent magnet Mg3, the maximum value of inverse magnetic field was 836 (kA/m), the minimum value thereof was 319 (kA/m), and the mean value thereof was 770 (kA/m).

As shown in FIG. 15b, in the case of the permanent magnet Mg1, a substantially uniform inverse magnetic field was generated at each corner portion except for both corner portions on the stator side. In addition, the results in FIG. 15c show that in the case of the permanent magnet Mg2, the largest inverse magnetic field was generated at rotor-rotational rear portions while the inverse magnetic field intensity decreased toward the rotor-rotational front portions. Further, as shown in FIG. 15d, in the case of the permanent magnet Mg3, a slightly large inverse magnetic field was generated in the center portion.

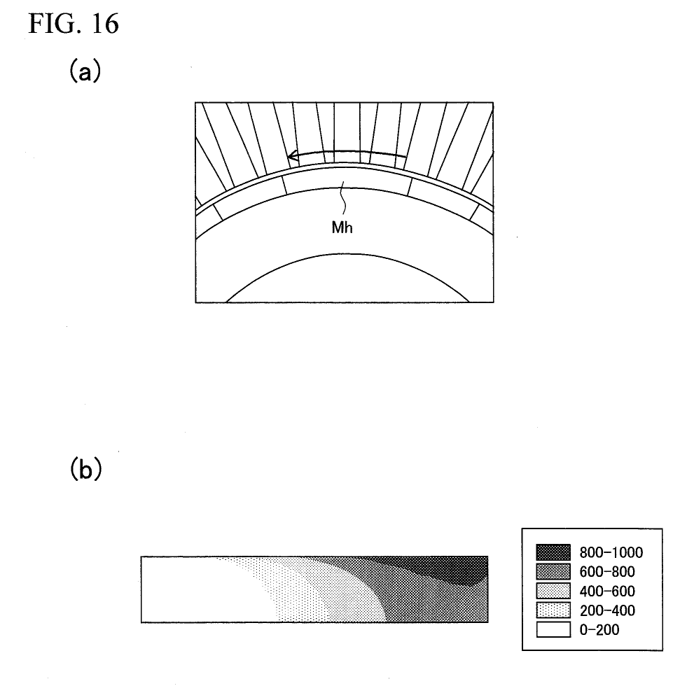

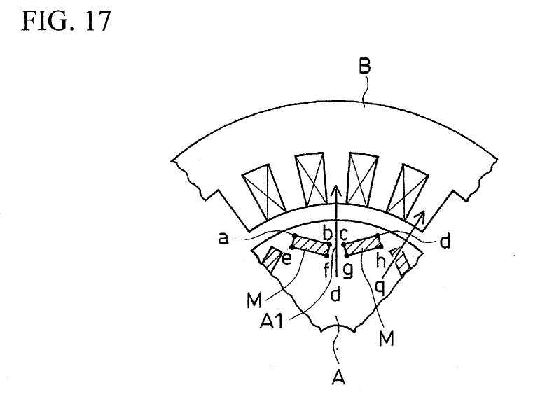

FIGS. 16a and 16b show results for the analysis model H in FIG. 8 (a distributed winding SPM motor). FIG. 16a is an enlarged view of permanent magnets. FIG. 16b shows analysis results for the permanent magnet Mh.

In FIG. 16b showing analysis results for the permanent magnet Mh, the maximum value of inverse magnetic field was 981 (kA/m), the minimum value thereof was −440 (kA/m), and the mean value thereof was 328 (kA/m).

The results in FIG. 16b show that in the cases of the permanent magnet Mh, the largest inverse magnetic field was generated at the rotor-rotational rear corner portion on the stator side while the inverse magnetic field intensity decreased toward a corner portion on the rotor-rotational-axis side, which was located diagonally from the above corner portion.

Based on the analysis results for each model, it has been noted that even if the pattern of permanent magnet arrangement in an IPM motor is changed, a large inverse magnetic field tends to be generated at a stator-side corner portion of the permanent magnet. Also, it has been noted that such tendency applies to SPM motors.

Accordingly, it has been demonstrated that when a permanent magnet in which the coercive force distribution shown in any one of FIGS. 2 to 4 is realized is used, the coercive force distribution corresponds to the distribution of inverse magnetic fields that can be applied to the permanent magnet. Such a permanent magnet has optimized coercive force regions and thus can be obtained at a minimal manufacturing cost.

In the case of a motor comprising the above rotor having magnets embedded therein of the present invention, embeddable permanent magnets have desired coercive force and magnetic flux density. In addition, the manufacturing cost thereof is significantly reduced. Therefore, such motor is preferable for recent hybrid vehicles and electric vehicles, for which the improvement of motor performance and the reduction of motor manufacturing costs are expected.

The present invention is described above in greater detail with reference to the following examples, although the technical scope of the present invention is not limited thereto. Various changes and modifications to the present invention can be made equally without departing from the spirit or scope thereof.

1. A rotor for a magnet-embedded motor which comprises a plurality of permanent magnets embedded therein, wherein
each permanent magnet is formed with a plurality of magnetic regions having different coercive forces that are determined based on the intensity of the inverse magnetic field that acts on each permanent magnet, the coercive forces of the plurality of magnetic regions being distributed toward the stator side or rotor-rotational-axis side, provided that a magnetic region having a relatively large coercive force is designated to be a region that is influenced by a relatively large inverse magnetic field.

2. The rotor for a magnet-embedded motor according to claim 1, wherein
each permanent magnet is formed into a rectangle as seen from a plane view, and wherein
the plurality of magnetic regions are provided in a manner such that a corner portion region on the stator side of the rectangle is the region having the largest coercive force (first region), the region abutting the first region is the region having the second-largest coercive force (second region) after the first region, and another region is the region having the third-largest coercive force after the second region.

3. The rotor for a magnet-embedded motor according to claim 1, wherein
each permanent magnet is formed into a rectangle as seen from a plane view,
the plurality of magnetic regions are formed by dividing the rectangle into a plurality of regions in the longitudinal direction,
the center region of the permanent magnet is the region having the smallest coercive force, and
the coercive force gradually increases in the divided regions toward the edge portion of the magnet.

4. The rotor for a magnet-embedded motor according to claim 1, wherein two permanent magnets are positioned relative to a single pole, provided that the two permanent magnets form an approximate V shape as seen from a plane view, the V shape extending from the rotor-rotational-axis side toward the stator side.

5. The rotor for a magnet-embedded motor according to claim 2, wherein at least one of two corner portions of each permanent magnet that are located on the rotor-rotational-axis side is truncated as seen from a plane view such that the plane view of the permanent magnet corresponds to the plane view of the relevant permanent magnet insertion slot of the rotor core.

6. A magnet-embedded motor comprising the rotor according to claim 1.
